(19) United States
(12) Patent Application Publication
(10) Pub. No.: US 2010/0009827 A1
(43) Pub. Date: Jan. 14, 2010

(54) Roller with a honeycomb-like pattern

(76) Inventor: Tai-Cheung Lee, Linkou Hsiang (TW)

Correspondence Address: BACON & THOMAS, PLLC, 625 SLATERS LANE, FOURTH FLOOR, ALEXANDRIA, VA, 22314-1176, US

(21) Appl. No.: 12/216,934

(22) Filed: Jul. 14, 2008

(51) Int. Cl. B21B 1/40; C03C 27/00

(52) U.S. Cl. 492/30; 428/632

(57) ABSTRACT

A transfer roller with a honeycomb-like pattern has a metal roller and a ceramic layer coated on a surface of the metal roller. The ceramic layer is formed with a plurality of hexagonal pattern units. The pattern units are closely configured so that each side of each pattern unit is adjacent to a corresponding side of another pattern unit. A shaft goes through an axis of the roller and protrudes from both ends of the axis. Since the roller has a ceramic layer with better erosion resistance than steel, the transfer roller has a longer lifetime. As the pattern units are hexagonal, a flat and uniform alignment film is achieved when the transfer roller is used to make liquid crystal displays.

### BACKGROUND OF THE INVENTION

1. Field of the Invention

The invention relates to a transfer roller and, in particular, to a transfer roller with a honeycomb-like pattern.

2. Description of Related Art

A patterned roller has applications in various technical fields. For example, such a roller can be used to make laser hologram label, transfer patterns on security labels, or the anilox roller used in the manufacturing of liquid crystal displays (LCD). Normally, a roller is formed with the desired pattern. The roller then transfers the pattern on to a target object. For the anilox rollers used in LCD manufacturing processes, polyimide (PI) solution is first applied uniformly on the anilox roller when coating the alignment film. The PI solution flows into the pattern units so that it is uniformly distributed on the anilox roller. The anilox roller then transfers the PI solution uniformly on an Asahi Kasei photosensitive resin (APR) plate. A printing cylinder then transfers the PI solution on the APR plate onto a glass substrate, forming the distributive film.

When making the patterned roller, the surface of the steel roller is first ground to remove unsmooth stuff thereon. The roller surface is then polished to produce a specular surface. Afterwards, a mold is used to cast the desired pattern on the roller surface. Finally, the roller surface is cleaned. This completes the production of a patterned roller.

Since a steel roller is less resistant to erosion, the pattern units thereon are often deformed after many times of uses. Therefore, such rollers have shorter lifetimes. In this case, these rollers can only be formed with helical or rectangular pattern units. However, for the anilox roller that helps coating alignment films in the LCD manufacturing processes, the helical or rectangular pattern units usually cannot uniformly distribute the PI solution on the anilox roller. As a result, the PI solution cannot be uniformly transferred on the APR plate. This in turn affects the production of a flat and uniform alignment film when the PI solution on the APR plate is printed onto the glass substrate. Not only is a flat and uniform alignment film impossible, the thickness of the transferred alignment film has only 400 angstrom (Å).

To overcome the shortcomings, the present invention provides a transfer roller with a honeycomb-like pattern to mitigate or obviate the aforementioned problems.

### SUMMARY OF THE INVENTION

In order for the transfer roller to have a longer lifetime and be more suitable for the LCD manufacturing processes, an objective of the invention is to provide a transfer roller with a honeycomb pattern and better erosion resistance so that it is ideal for LCD manufacturing.

In accord with the above-mentioned objective, the transfer roller includes a metal roller and a roller shaft. The metal roller has a ceramic layer formed thereon. The surface of the ceramic layer is formed with a plurality of hexagonal pattern units closely packed together in such a way that each side of each pattern unit is adjacent to a corresponding side of another pattern unit, thereby forming a honeycomb pattern. The roller shaft goes through the roller axis and protrudes from both ends of the roller axis.

Since the roller is formed with a ceramic layer with better resistance to erosion than steel materials, the roller has a longer lifetime. When using the roller in LCD manufacturing processes, the hexagonal pattern units can uniformly distribute a PI solution on the disclosed roller. Subsequently, the PI solution can be uniformly transferred on an APR plate. As a result, a flat and uniform alignment film of a desired thickness can be printed onto a glass substrate.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the a transfer roller with a honeycomb-like pattern in accordance with the present invention;

FIG. 2 is the plan view of a portion of the transfer roller magnified 244 times in accordance with the present invention;

FIG. 3 is a cross-sectional and side view of a portion of a ceramic layer; and

FIG. 4 is a correspondence table between the specification of the pattern unit and the thickness of a printed alignment film.

### DETAILED DESCRIPTION OF THE PREFERRED EMBODIMENT

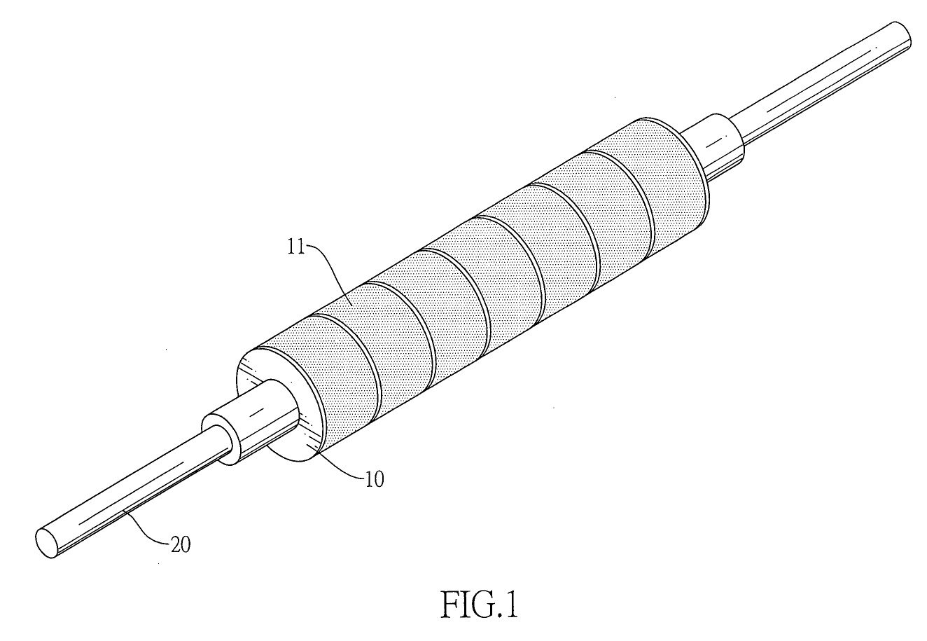

With reference to FIG. 1, a transfer roller with a honeycomb-like pattern includes a metal roller 10 and a roller shaft 20.

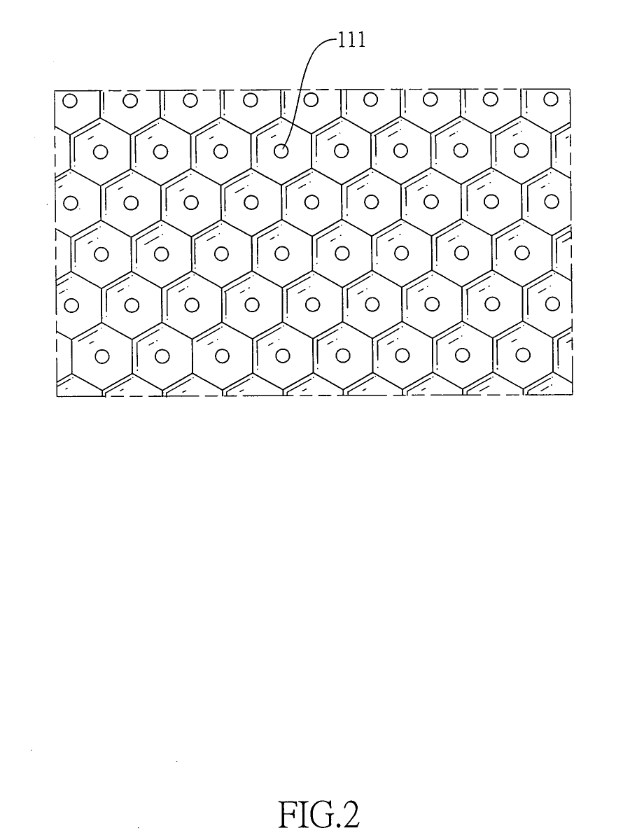

The surface of the metal roller 10 is formed with a ceramic layer 11. As shown in FIG. 2, the surface of the ceramic layer 11 is formed with multiple hexagonal pattern units 111 closely configured together. Each side of each pattern unit 111 is adjacent to a corresponding side of another adjacent pattern unit 111. In this embodiment, an auxiliary bond layer (not shown) is provided between the ceramic layer 11 and the metal roller 10. The auxiliary bond layer enhances the bonding effect of the ceramic layer 11 because the ceramic particles do not adhere well on metal.

The auxiliary bond layer contains 70% to 80% of Ni. The rest 20% to 30% is a mixture of WC—Co, Cr₃C₂, Cr₃C₂—NiCr, and Cr. 95% of the ceramic particle material is Cr₂O₃. This is because Cr₂O₃ can be readily cut by laser. The rest 5% in the ceramic particle material is a mixture of Al₂O₃, TiO₂, ZrO₂, and Y₂O₃. This mixture increases the erosion resistance of the ceramic layer 11 and allows laser to cut the ceramic layer 11 much easier. Besides, each pattern unit 111 is a right hexagon. Any two adjacent pattern units 111 subtend an angle of 60 degrees. Therefore, they present a honeycomb-like pattern.

The roller shaft 20 extends through the axis of the roller 10 and protrudes from both ends of the roller axis.

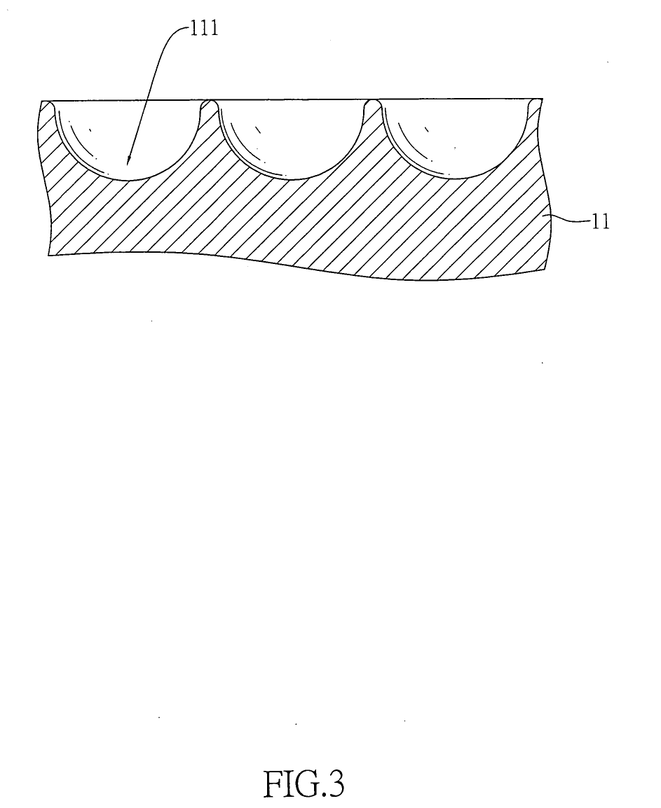

With reference to FIG. 3, each pattern unit 111 is a concave portion formed by hitting the ceramic layer 11 with a laser beam. As an example, the roller is used in the manufacturing process of LCD to print alignment film onto a glass substrate. Since the thickness of the alignment film is an important factor for the LCD display quality, the PI solution adhered on the roller has to be precisely controlled. Furthermore, the width and depth of each concave portion directly affect whether the PI solution filled therein is sufficient. This determines whether the PI solution can be completely transferred onto an APR plate. Therefore, the transfer roller structure is crucial in printing the alignment film.

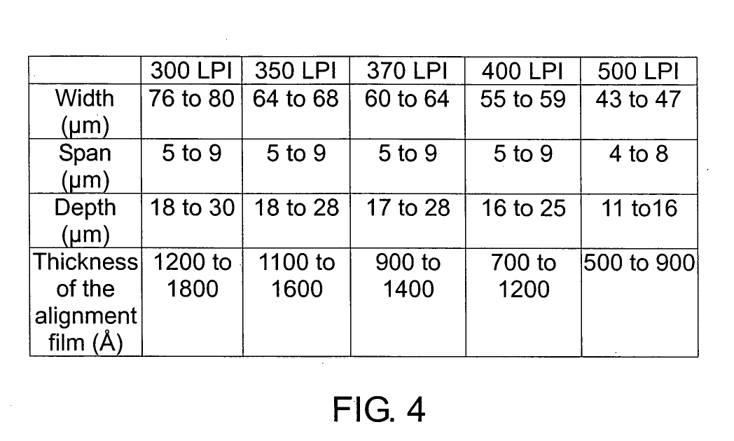

With reference to FIG. 4, if the roller has 300 lines per inch (LPI), each concave portion has a width of 76 to 80 microns and a depth of 18 to 30 microns, and the span between adjacent concave portions is 5 to 9 microns, the thickness of the printed alignment film is 1200 to 1800 angstroms (Å). If a roller has 500 LPI, each concave portion has a width of 43 to 47 microns, a depth of 11 to 16 microns, and the span between adjacent concave portions is 4 to 8 microns, the printed alignment film has a thickness of 500 to 900 Å. Pattern units 111 of different densities and sizes can be used in the manufacturing processes for LCD's of different sizes and purposes.

In summary, the invention forms a ceramic layer on the surface of a metal roller so that the disclosed roller has better resistance to erosion than a conventional roller. The hexagonal pattern units formed on the ceramic layer have the effect of transferring uniformly. By adjusting the width and depth of the pattern units, the thickness of the printed alignment film during the LCD manufacturing process can be effectively controlled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transfer roller with a honeycomb-like pattern comprising:
a metal roller having a surface formed with a ceramic layer on which multiple hexagonal pattern units being closely configured together are formed in such a way that each side of each pattern unit is adjacent to one side of another pattern unit; and
a roller shaft extending through an axis of the roller and protrudes from both ends of the axis.

2. The transfer roller with a honeycomb-like pattern as claimed in claim 1, wherein each pattern unit is a right hexagon and any two adjacent pattern units subtend an angle of 60 degrees.

3. The transfer roller with a honeycomb-like pattern as claimed in claim 1 wherein each pattern unit is a concave portion.

4. The transfer roller with a honeycomb-like pattern as claimed in claim 2 wherein each pattern unit is a concave portion.

5. The transfer roller with a honeycomb-like pattern as claimed in claim 3, wherein each pattern unit has a width of 76 to 80 microns and a depth of 18 to 30 microns, and the span between each two adjacent pattern units is 5 to 9 microns.

6. The transfer roller with a honeycomb-like pattern as claimed in claim 4, wherein each pattern unit has a width of 76 to 80 microns and a depth of 18 to 30 microns, and the span between each two adjacent pattern units is 5 to 9 microns.

7. The transfer roller with a honeycomb-like pattern as claimed in claim 3, wherein each pattern unit has a width of 64 to 68 microns and a depth of 18 to 28 microns, and the span between each two adjacent pattern units is 5 to 9 microns.

8. The transfer roller with a honeycomb-like pattern as claimed in claim 4, wherein each pattern unit has a width of 64 to 68 microns and a depth of 18 to 28 microns, and the span between each two adjacent pattern units is 5 to 9 microns.

9. The transfer roller with a honeycomb-like pattern as claimed in claim 3, wherein each pattern unit has a width of 60 to 64 microns and a depth of 17 to 28 microns, and the span between each two adjacent pattern units is 5 to 9 microns.

10. The transfer roller with a honeycomb-like pattern as claimed in claim 4, wherein each pattern unit has a width of 60 to 64 microns and a depth of 17 to 28 microns, and the span between each two adjacent pattern units is 5 to 9 microns.

11. The transfer roller with a honeycomb-like pattern as claimed in claim 3, wherein each pattern unit has a width of 55 to 59 microns and a depth of 16 to 25 microns, and the span between each two adjacent pattern units is 5 to 9 microns.

12. The transfer roller with a honeycomb-like pattern as claimed in claim 4, wherein each pattern unit has a width of 55 to 59 microns and a depth of 16 to 25 microns, and the span between each two adjacent pattern units is 5 to 9 microns.

13. The transfer roller with a honeycomb-like pattern as claimed in claim 3, wherein each pattern unit has a width of 43 to 47 microns and a depth of 11 to 16 microns, and the span between each two adjacent pattern units is 4 to 8 microns.

14. The transfer roller with a honeycomb-like pattern as claimed in claim 4, wherein each pattern unit has a width of 43 to 47 microns and a depth of 11 to 16 microns, and the span between each two adjacent pattern units is 4 to 8 microns.

15. The transfer roller with a honeycomb-like pattern as claimed in claim 1, wherein an auxiliary bond layer is provided between the ceramic layer and the surface of the metal roller.

16. The transfer roller with a honeycomb-like pattern as claimed in claim 2, wherein an auxiliary bond layer is provided between the ceramic layer and the surface of the metal roller.

17. The transfer roller with a honeycomb-like pattern as claimed in claim 3, wherein an auxiliary bond layer is provided between the ceramic layer and the surface of the metal roller.

18. The transfer roller with a honeycomb-like pattern as claimed in claim 4, wherein an auxiliary bond layer is provided between the ceramic layer and the surface of the metal roller.

19. The transfer roller with a honeycomb-like pattern as claimed in claim 18, wherein 70% to 80% of the auxiliary bond layer material is Ni and the rest 20% to 30% is a mixture of WC—Co, Cr3C2, Cr3C2-NiCr, and Cr.

20. The transfer roller with a honeycomb-like pattern as claimed in claim 18, wherein 95% of the ceramic particle material is Cr2O3 and the rest 5% is a mixture of Al2O3, TiO2, ZrO2, and Y2O3.
